(19) United States
(12) Patent Application Publication
(10) Pub. No.: US 2010/0211616 A1
(43) Pub. Date: Aug. 19, 2010

(54) Performance by Avoiding Disk I/O for Deduplicated File Blocks

(76) Inventors: Rajesh Khandelwal, Bangalore (IN); Vandana Shah, Bangalore (IN)

Correspondence Address: JOHN R LEY, LLC, 5299 DTC BLVD, SUITE 340, GREENWOOD VILLAGE, CO, 80111, US

(21) Appl. No.: 12/371,703

(22) Filed: Feb. 16, 2009

(51) Int. Cl. G06F 12/16; G06F 12/08; G06F 12/00

(52) U.S. Cl. 707/812; 710/52; 711/118; 711/E12.001; 711/E12.103

(57) ABSTRACT

A computer having deduplicated data stores files comprised of file blocks in a volume. File blocks are copied from the volume to memory as needed by processes. An operating system searches a memory index for physical attributes associated with a deduplicated file block to determine whether a copy of the deduplicated file block is already resident in the memory. If a copy of the deduplicated file block is already resident in the memory, the operating system creates another copy of the deduplicated file block within the memory and updates the memory index, thus avoiding having to copy the deduplicated file block from the volume and improving the performance of the computer.

This invention relates to computer memory buffer caches which store copies of file blocks. More particularly, the present invention relates to a new and improved computer memory buffer cache and method which avoids unnecessary disk reads in a computer having deduplicated data thus improving the performance of the computer.

### BACKGROUND OF THE INVENTION

Modern computers employ a variety of different types of data storage devices on which data is stored. These data storage devices include magnetic and solid state disk drives (“disks”), memories such as random access memory (RAM), and central processing unit (CPU) caches. Different data storage devices have different tradeoffs in terms of cost, data storage capacity and data access speed or latency. Generally, disk drives have large storage capacities but slow access times, CPU caches have low storage capacities but fast access times, and memories have storage capacities and access times in between those of disk drives and CPU caches.

The data storage devices of a computer are typically organized in what is known as a storage hierarchy or tiered structure. The tiered structure refers to the relative closeness of the data storage device to one or more processing cores of the CPU. The CPU cache is the closest data storage device to the processing cores. Modern CPU caches are typically created on the same silicon die as the processing cores of the CPU. The memory is the next closest data storage device to the processing cores and exchanges data with the CPU cache. Disks are the furthest data storage device from the CPU cores and exchange data with the memory.

The memory and CPU cache of a computer are usually volatile storage devices which require power in order to store data. Disks are persistent data storage devices and store data regardless of whether the disks are powered on or off. Therefore, to help prevent data loss, all of the data of a computer is generally stored on disks except for data that is currently being processed by programs executing on the processing cores. In order for the CPU to execute a program or operate on data within a file (collectively “files”) stored on the disks, that file must be loaded from the disks to the memory, and then from the memory to the CPU cache in order for the processing cores to operate on or execute the file. The file may be loaded from the disks to the memory in its entirety or in predetermined amounts. The loading of a file from the memory to the CPU cache may be performed in several different loading operations each involving the transfer of a small portion of the file from the memory to the CPU cache. An operating system is typically read from the disks into memory upon starting the computer and generally manages the flow of data through the computer including the flow of data between the disks and the memory, amongst other tasks. The CPU and other hardware typically manages the CPU cache and the flow of data between the memory and the CPU cache.

A computer would be so slow as to be essentially useless if it had to perform a read operation from the disks every time the CPU needed a new program instruction or piece of data from a file stored on the disks. Various methods are therefore used in an attempt to predict which data is likely to be requested by the CPU in the immediate future, and to keep the CPU cache and the memory as efficiently full of the predicted data as possible in order to minimize the number of required disk operations as well as to minimize the chance that the CPU cores will sit idle while waiting for data to be read from the disks to the memory and then to the CPU cache. One such method involves retaining recently accessed files or portions of files in memory after the program which requested the files is finished accessing the files. The reason for keeping recently accessed files in the memory is based on the likelihood that those files may be needed by the operating system or other programs executing on the computer in the immediate future. If the files are already present within the memory when they are needed, then a disk operation to load the files from the disks to the memory is avoided and the performance of the computer is improved. The portion of the memory which is used for storing recently read files is called a “buffer cache” herein.

Disks are typically combined or subdivided into logical storage areas called volumes. Files are stored within a volume in a predetermined manner known as a file system. Typically, a volume has a basic storage unit referred to as a block which represents the smallest amount of allocatable data storage space within the volume or disks. File data is typically stored in block sized portions of the volume. A block sized portion of a file which is stored in a block sized portion of the volume, or other data storage device, is referred to as a file block. Overhead data used by the filesystem to describe or organize file data is referred to as metadata. Typically, each file is assigned a unique number referred to as an inode number in order to distinguish between different files within the volume. An inode file stored on the volume correlates inode numbers with metadata associated with the files.

Each block sized portion of the data storage space of a volume is uniquely addressable. A particular type of metadata are the block addresses within the volume which contain file blocks. A common way of organizing these addresses of the blocks (known as file block pointers) of the volume which contain the file blocks of the file is to use a tree data structure. The tree data structure contains at least a top node and the file block pointers which point to the file blocks which constitute the file. The tree data structure for each file is stored in one or more blocks of the volume outside of the inode file. All of the file block pointers of a file can be identified if the location of the top node of the tree data structure for the file is known. The file block pointers within a tree data structure are ordered, and the file blocks pointed to by the file block pointers are thus also ordered. The particular position of a file block within a file is referred to as a file offset or file block number (FBN), and represents the block position of the file block from the start of the file. Typically, the block address of the head node of the tree data structure for a particular file is stored in the inode file and can be identified if the inode number of the file is known.

Storage space within the buffer cache is also typically logically divided into fixed sized units called blocks. The block size of the buffer cache is usually chosen to equal the block size of the volume on which the files are stored. An index is typically stored in the memory which contains logical attributes of the file blocks currently stored in the buffer cache. Such information typically includes the FBN of the file block stored in a particular block, the inode number of the file whose file block is stored in the particular block, and buffer management related information such as a dirty bit which indicates whether or not the buffer block has been modified and needs to eventually be written back to disk.

A relatively recent development in data storage technology is data deduplication. Data deduplication involves identifying file blocks between or within files which are identical and then removing all but one copy of the identical file blocks. There are different reasons why file blocks within a file and between files may become duplicated. Some programs create essentially blank files whose data is initially all zeros. Instead of storing multiple file blocks which contain only zeros, one zero filled file block is stored on the volume and all of the file block pointers for the file point to that one zero block. File blocks are duplicated between files when a file is copied or when different versions of a file are stored on the same volume. Prime candidates for data deduplication are backup servers and servers with a high degree of virtualization.

Data deduplication can be implemented in different ways. One common way of implementing data deduplication is to pass the data of each file block through an algorithm to generate a key. The keys are much shorter than the length of the file blocks. File blocks having the same key are then compared bit by bit to determine if the file blocks are identical. If two file blocks are determined to be identical, one of the file blocks is deleted and the file block pointers previously associated with the deleted file block are changed to point the remaining file block.

While data deduplication has resulted in less data storage space requirements for computers, it has not necessarily resulted in less disk reads. Although a particular file may be data deduplicated on disk, files or portions thereof in the buffer cache are not typically also deduplicated. This is because file blocks in the buffer cache are associated with specific logical attributes requested by a process and are subject to modification by that process. As a result, the operating system may read blocks of a file into the buffer cache without regard to whether or not the particular block has been deduplicated.

### SUMMARY OF THE INVENTION

The present invention recognizes and responds to an inefficiency in the way file blocks are read from disk to memory in computers having deduplicated data.

In one embodiment of the invention, a process requests that the operating system load a particular file block into the buffer cache of the memory. The operating system searches for the logical attributes of the file block in a primary buffer cache index. If the logical attributes for the file block are found within the primary buffer cache index, the operating system informs the process of the memory address of the buffer cache which contains the requested file block. If the logical attributes for the file block are not found within the primary buffer cache index, the operating system determines the physical attributes associated with the requested file block. The operating system then searches a secondary buffer cache index for the physical attributes associated with the requested file block. If the searched for physical attributes are found within the secondary buffer cache index, the operating system determines the memory address which contains a copy of the requested file block associated with those physical attributes. A copy is then made of the file block corresponding to the physical attributes but not the logical attributes of the requested file block. This copy is stored in a new location within the buffer cache. The primary and secondary buffer cache indexes are then updated with the logical and physical attributes of the requested file block, respectively. In the event that the physical attributes of the requested file block are not found within the secondary buffer cache index, the operating system loads the requested file block from disk into an unused location within the buffer cache.

Since deduplicated file blocks share physical but not logical attributes, searching a buffer cache index for the physical attributes in addition to the logical attributes of a requested file block occasionally results in the discovery that a copy of the requested file block having the same physical but different logical attributes is already present within the buffer cache. When it is discovered that such a copy of the requested file block is already present in the buffer cache, a new copy of that file block is created within the buffer cache and the indexes are updated with the logical and physical attributes of the requested file block. A disk operation to retrieve the requested file block is avoided by copying the copy of the requested file block already present within the buffer cache. The performance of the computer is improved as a result of avoiding unnecessary disk read operations. The extent of the performance improvement corresponds to the degree to which data has been deduplicated on the computer. Thus, the performance of a computer having a high degree of deduplicated data is greatly improved as a result of incorporating the present invention.

One aspect of the invention involves a method of reducing disk related input/output operations in a computer having deduplicated data. The method involves receiving a request to load a deduplicated file block into memory. The physical attributes associated with the deduplicated file block are determined. A buffer cache index is searched for the physical attributes. The deduplicated file block is copied from an original location to a new location in the memory when the physical attributes are found in the buffer cache. The buffer cache index is then updated with the physical attributes.

Another aspect of the invention involves a computer having deduplicated data. The computer has a central processing unit and a volume. Files are stored within the volume. A memory of the computer contains copies of some of the file blocks which make up the files stored in the volume. An operating system is stored in the memory and executed by the central processing unit. A buffer cache index is stored within the memory and associates memory addresses with physical attributes corresponding to file blocks stored at those memory addresses. The operating system determines whether or not a particular file block is present within the memory by searching the buffer cache index for an entry containing the physical attributes associated with that particular file block.

Subsidiary aspects of the invention include: using two separate buffer cache indexes for storing logical and physical attribute information associated with file blocks stored within the memory; determining logical attributes associated with a deduplicated file block; searching for the logical attributes in the buffer cache index; and searching for the physical attributes only after the logical attributes are searched for and not found.

A more complete appreciation of the present invention and its scope may be obtained from the accompanying drawings, which are briefly summarized below, from the following detailed description of a presently preferred embodiment of the invention, and from the appended claims.

### BRIEF DESCRIPTION OF THE DRAWINGS

FIG. 1 is a diagrammatic illustration of a computer having CPU, memory and a disk subsystem which implements the present invention.

FIG. 2 is a diagrammatic illustration of the computer shown in FIG. 1, showing details of the CPU, memory and a volume which uses data storage space of the disk subsystem.

FIG. 3 is a diagrammatic illustration of a an inode file and buffer trees of the computer shown in FIG. 1.

FIG. 4 is a flow chart detailing a process for ensuring a file block in a computer having deduplicated data is present within a buffer cache of the memory of the computer shown in FIG. 2.

FIG. 5 is a diagrammatic illustration of a network storage server which implements the present invention and a client computer. The illustration represents the state of the network storage server prior to receiving a file request from the client computer.

FIG. 6 is a diagrammatic illustration of the computers shown in FIG. 2. The illustration represents the state of the network storage server after having processed the file request from the client computer.

### DETAILED DESCRIPTION

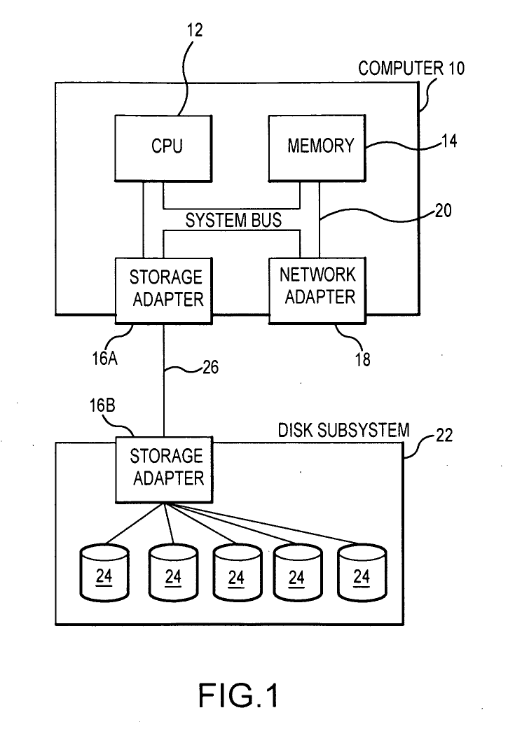

A computer 10 which implements and embodies the present invention is shown in FIG. 1. The computer 10 includes a CPU 12, a memory 14, a storage adapter 1 6A and a network adapter 18. A system bus 20 connects and facilitates communication between the CPU 12, the memory 14, the storage adapter 16 and the network adapter 18. A disk subsystem 22 contains a plurality of disk drives 24 on which data files (“files”) are stored. The disk drives 24 are connected to a storage adapter 16B which is further connected to the storage adapter 16A by a communications cable 26. The disk drives 24 may be magnetic or solid state disk drives such as flash drives, or equivalents. The network adapter may be connected to a communications network (not shown) so that the computer 10 can communicate with other computers. Within the memory 14 is an operating system 28. The operating system 28 performs several important management functions for the computer 10, including generally controlling the flow of data between the disk drives 24, the memory 14 and the CPU 12. The operating system 28 is programmed to implement the present invention in this embodiment of the invention.

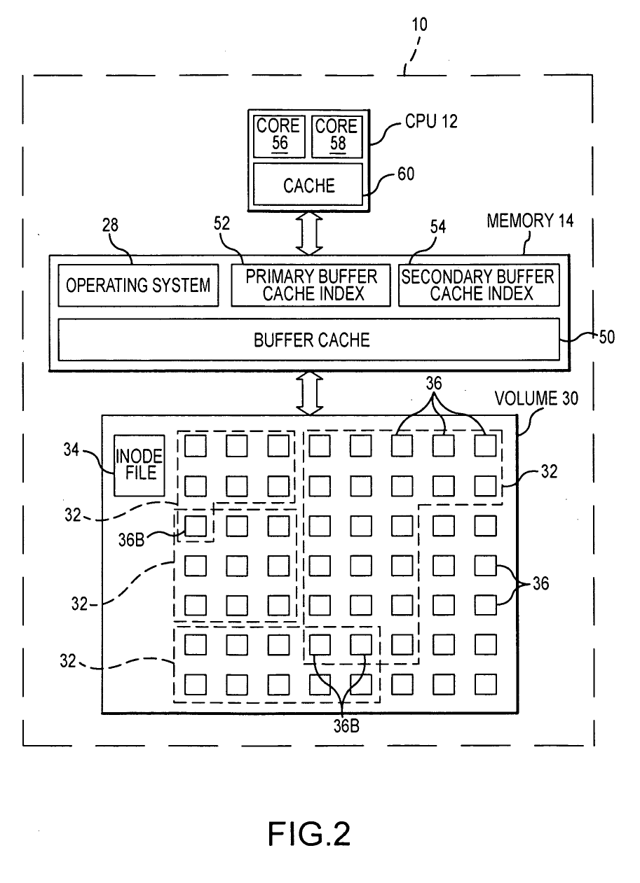

The operating system 28 organizes the available data storage space of the disk drives 24 into a logical storage space called a volume 30, shown in FIG. 2. The operating system 28 uses a file system to store files 32 within the volume 30. A file system is a predetermined method of organizing, storing and accessing files within a volume. The operating system 28 uses an inode file 34 to store information about the files 32 stored within the volume 30. Each of the files 32 within the volume 30 is assigned a unique inode number by the operating system 28 and each of the files 32 can be identified by the inode number of the particular file 32.

The data of each of the files 32 is divided into one or more file blocks 36. Each file block 36 is a block sized portion of file data. Each of the file blocks 36 within the volume 30 is stored at a unique address called a volume block address (“VBN”). Each VBN of the volume 30 correlates directly to a specific physical block on one of the disk drives 24. Similarly to the volume 30, the data storage space on each of the disk drives 24 is also divided into several blocks, each having a unique physical block number (“PBN”). The operating system 28 performs translations between VBNs and PBN/disk identification numbers (IDs) as part of the implementation of the file system by the operating system 28.

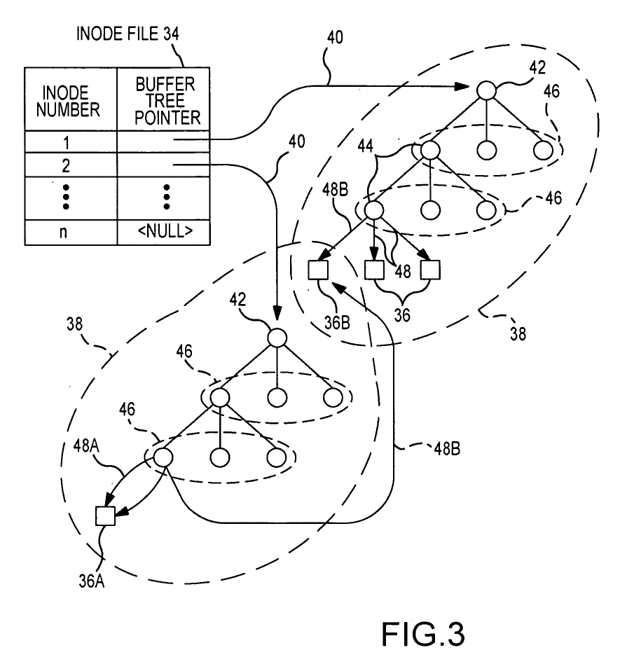

The operating system 28 correctly associates certain file blocks 36 with a particular one of the files 32 with the assistance of a buffer tree 38, as shown in FIG. 3. A buffer tree 38 is a tree-like data structure which is stored within the volume 30. There is a unique buffer tree 38 associated with each of the files 32. Each inode number within the inode file 34 is associated with a pointer 40 which points to a top node 42 of the buffer tree 38 for the file 32 assigned that inode number. A pointer is an address within the volume 30 which includes a VBN or some variation of a VBN. Each top node 42 contains one or more pointers 40 which point to one or more intermediate nodes 44 within the buffer tree 38. Similarly, each of the intermediate nodes 44 may contain one or more pointers 40 which point to other intermediate nodes 44 or which point to file blocks 36. Each of the intermediate nodes 44 which is the same number of pointers 40 from the top node 42 are considered to be at the same level 46 within the buffer tree 38. The lower most level 46 of intermediate nodes 44 within a buffer tree 38 contains file block pointers 48 which point to, or otherwise specify the location of the file blocks 36 within the volume 30 that contain the actual file data of the particular file 32 associated with the buffer tree 38. There is typically a maximum number of pointers 40 that any of the nodes 42 or 44 can store, and thus the particular buffer tree 38 related to a particular file 32 will have more or less levels 46 depending on the relative size of the file 32. Each of the file blocks 36 pointed to by the file block pointers 48 of the buffer tree 38 associated with a particular file 32 is ordered. The relative position of a particular file block 36 within a file 32 is measured by the number of file blocks 36 between the start of the file 32 and the particular file block 36. This number is known as the file block number (“FBN”) of the file block 36.

A particular file 32 may have duplicate file block pointers 48 associated with different FBNs which point to the same file block 36, such as file block pointers 48A which both point to file block 36A in FIG. 3. Also, file block pointers 48 associated with different buffer trees 38 may point to the same file block 36, such as file block pointers 48B which point to file block 36B. The duplicate file block pointers 48A and 48B are the result of data deduplication within the volume 30.

Data duplication involves identifying identical file blocks within the volume and then removing all but one of the identified identical file blocks for the purpose of conserving data storage space within the volume. A well known method of implementing data deduplication involves passing the data of each file block stored in the volume through an algorithm to generate a key, and storing the keys associated with each of the file blocks in a key table. For example, an algorithm to generate a key could be similar to an algorithm which generates a checksum. A key table may be implemented as an array data structure, with the keys corresponding to element positions within the array. The keys from the key table are then compared with one another and if two blocks share the same key, the data within those two blocks is compared to determine if there is an identical match. If there is an identical match, the VBN which stored one of the file blocks is freed and the data block pointers which originally pointed to the freed file block are changed to point to the VBN which stores the remaining, now deduplicated, file block. The mechanics of freeing a data block within a volume are dependent upon how the filesystem is implemented on the volume. In one embodiment of a volume, freeing a data block may involve adding the VBN at which the data block was stored within the volume to a free block list, which may be implemented as an array data structure. Data deduplication can save significant amounts of data storage space on computers which would otherwise store many copies of identical file blocks. Data storage space saving opportunities are particularly good on storage server computers which tend to retain multiple copies of the same, or of substantially the same file.

Referring back to FIG. 1, within the memory 14 is a buffer cache 50, a primary buffer cache index 52 and a secondary buffer cache index 54. The buffer cache 50 is an area of the memory 14 that is used for storing file blocks 36. Typically, all otherwise unused areas of the memory 14 are used as the buffer cache 50. Thus, the size of the buffer cache 50 and the particular memory addresses which constitute the buffer cache 50 typically change over time. File blocks 36 are read into the buffer cache 50 as they are needed by the different processes executing on the CPU 12, as described more fully below. The primary buffer cache index 52 correlates specific memory addresses of the memory 14 which constitute the buffer cache 50 with preselected logical attributes of the file blocks 36 which have been copied to (or are in the process of being copied to) those specific memory addresses. The secondary buffer cache index 54 correlates those same specific memory addresses with preselected physical attributes associated with the file blocks 36 stored at those memory addresses. The physical attributes associated with a particular file block 36 include those attributes that uniquely identify where the file block 36 is located within the volume 30 or within the disk drives 24, such as the VBN where the file block is stored within the volume 30. The primary and secondary buffer cache indexes 52 and 54 may be implemented as well known conventional data structures, such as a multi-dimensional array.

The CPU 12 of this described embodiment of the invention contains two processing cores 56 and 58 as well as a CPU cache 60. The processing cores 56 and 58 execute one or more processes or programs, including the operating system 28. As the processing cores 56 and 58 of the CPU 12 execute these processes, the cores 56 and 58 attempt to predict the portions of files (“file snippets”) containing data or program instructions that the processes might need in the immediate future. The CPU 12 attempts to keep the CPU cache 60 full of these predicted file snippets according to one or more predetermined prediction algorithms. The CPU 12 keeps the CPU cache 54 full of these predicted file snippets by occasionally communicating to the operating system 28 that the CPU 12 needs a particular file snippet.

The example just described of the CPU 12 requesting a particular file snippet from the operating system 28 is but one example of something that causes the operating system 28 to ensure that a particular file block has been loaded into the buffer cache 50. More generally, a particular process requests that the operating system 28 load a particular file block into the buffer cache 50. After the operating system 28 ensures that the requested file block has been loaded into, or is already present within the buffer cache 50, the operating system 28 returns or otherwise communicates to the requesting process the memory address within the buffer cache 50 which contains the requested file block. The operating system 28 identifies the requested file block by the logical attributes of the file block, such as the inode number of the file containing the requested file block and the FBN of the file block. These logical attributes may be communicated to the operating system 28 as part of the request for the requested file block or may be derived from other information, such as a file handle. The operating system 28 ensures that the requested file block is present within the buffer cache 50 and that the logical attributes in the primary buffer cache index 52 corresponding to the memory location of the requested file block within the buffer cache 50 are the same logical attributes associated with the requested file block in the request from the requesting process.

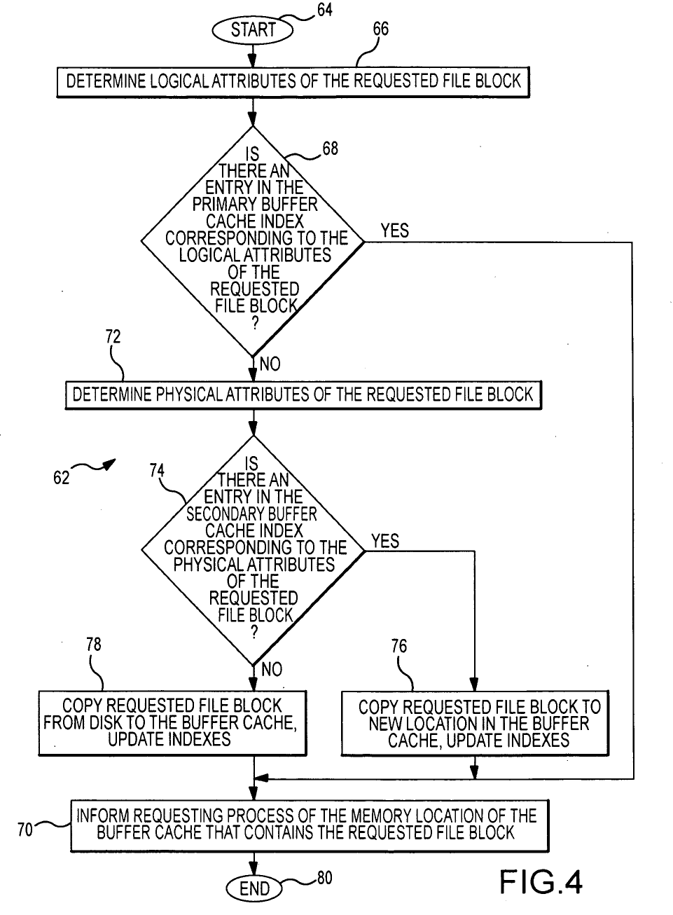

An exemplary process flow 62 for ensuring that a requested file block has been loaded into the buffer cache 50 is shown in FIG. 4. The process flow 62 is executed by the operating system 28 (FIG. 2) or related program or process upon receiving a request for a requested file block from a requesting process or execution thread. The process flow 62 starts at 64. At 66, the logical attributes of the requested file block are determined. The logical attributes include at least an attribute which uniquely identifies the appropriate file which contains the requested file block, such as an inode number for the file, as well as an attribute which uniquely identifies the position of the requested file block within the appropriate file, such as an FBN. Embodiments of the present invention which involve multiple volumes may also include a unique volume identification number with the logical attributes. The logical attributes of the requested file block are usually either passed to the operating system 28 by the requesting process or derived by the operating system 28 using conventional methods from shared information between the operating system 28 and the requesting process.

It is then determined whether or not an entry corresponding to the logical attributes of the requested file block are present within the primary buffer cache index 52 (FIG. 2), at 68. The presence of an entry in the primary buffer cache index 52 corresponding to the logical attributes of the requested file block indicates that the requested file block is already in the buffer cache 50 (FIG. 2). If the determination at 68 is affirmative, the logic flow progresses to 70. If the determination at 68 is negative then the logic flow progresses to 72.

At 72, the physical attributes of the requested file block are determined. Physical attributes include those attributes which uniquely identify the requested file block within the volume or on the physical disk in which the file block is stored, such as a VBN or a PBN/disk ID combination. The VBN of the requested file block may be discovered by reading the value of the file block pointer corresponding to the FBN of the requested file block within the buffer tree 38 (FIG. 3) corresponding to the file 32 (FIG. 2) which contains the requested file block. Preferably, a copy of the buffer tree 38 related to a particular file is loaded into the memory 14 (FIG. 2) whenever a file block of that particular file is loaded into the buffer cache 50 so that an extra disk access just to determine the physical attributes of a file block which may already be loaded into the buffer cache can be avoided.

The secondary buffer cache index 54 (FIG. 2) is then searched for an entry corresponding to the physical attributes of the requested file block, at 74. The presence of the physical attributes of the requested file block within the secondary buffer cache index 54 indicates that a copy of the requested file block is already resident within the buffer cache 50. However, this copy of the requested file block does not share the same logical attributes of the requested file block at this point in the process flow 62 since those logical attributes where not present in the primary buffer cache index 52 as per the determination at 68. Thus, if there is a copy of the requested file block in the buffer cache 50 at this point in the process flow 62, that copy is associated with a different set of logical attributes than the logical attributes associated with the requested file block. If the physical attributes corresponding to the requested file block are present within an entry of the secondary buffer cache index 54, the process flow 62 continues to 76. If the physical attributes corresponding to the requested file block are not present within an entry of the secondary buffer cache index 54, the process flow 62 continues to 78.

At 76, the file block in the buffer cache corresponding to the physical attributes of the requested file block is copied to a new location within the buffer cache 50. The primary and secondary buffer cache indexes are then updated with the logical and physical attributes, respectively, of the requested file block corresponding to the entries of the memory address of the buffer cache at which the new copy was created. At this point in the process flow 62, it can be deduced that the requested file block is stored in the volume as a deduplicated file block. In other words, there is at least one other file block pointer, either associated with the same file or a different file, that points to the location within the volume where the requested file block is stored, besides the file block pointer associated with the inode number and FBN of the requested file block. As previously stated, the operating system communicates to the requesting process the memory address (or equivalent) of requested file block, and not merely the memory address of a copy of the requested file block associated with different logical attributes than those of the requested file block. This is primarily because the requesting process may modify the requested file block. Since the requested file block at this point in the process flow 62 is a deduplicated file block, care must be taken to ensure that a modification of the requested file block results in a reverse data deduplication, or storing of the modified file block to a new unused location within the volume. This ensures that the file which shares the deduplicated file block with the file corresponding to the requested file block is not inadvertently modified.

If the determination at 74 is negative, then there is not a copy of the requested file block within the buffer cache 50 and the process flow 62 proceeds to 78. At 78, the physical location of the requested file block within the volume 30 (FIG. 2) is determined similarly to the determination of the physical attributes at 72, and that physical location information is used to locate and copy the requested file block from the volume 30 to the buffer cache 50. The logical and physical attributes of the requested file block are also updated in the primary and secondary buffer cache indexes at the entries corresponding to the memory location to which the requested file block was copied.

The process flow 62 continues from 78, 76 and an affirmative determination at 68 to 70 where the requesting process is informed of the memory location within the buffer cache 50 that contains the requested file block. The process flow 62 ends at 80.

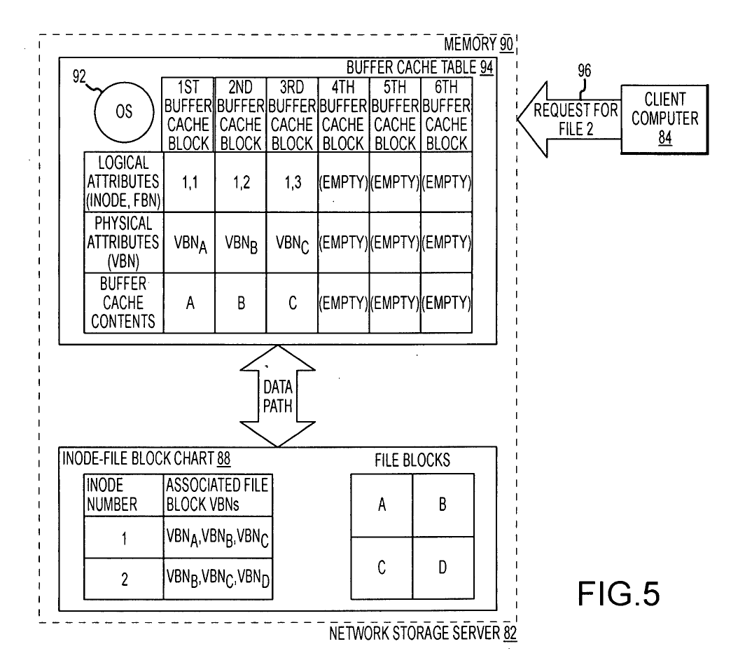

A network storage server 82 which implements the process flow 62 is shown in FIG. 5. The network storage server 82 stores files on behalf of client computers, such as client computer 84. The network storage server 82 and the client computer 84 communicate and exchange files according to predefined protocols over a communications network (not shown). The network storage server 82 includes a volume 86 in which files are stored. Four file blocks represented by the letters A, B, C and D are shown within the volume 86. The locations of each of the file blocks A, B, C, and D within the volume 86 are represented by VBN_{A}, VBN_{B}, VBN_{C} and VBN_{D}, respectively. An inode-file block chart 88 summarizes the relevant information of an inode file and buffer trees (not shown) which are part of a filesystem of the volume 86. A first file (“file one”) having an inode number of one is shown as being associated with file blocks A, B and C. A second file (“file two”) having an inode number of two is shown as being associated with file blocks B, C and D. File blocks B and C are deduplicated file blocks since they are both associated with more than one file.

The network storage server 82 also includes a memory 90. The memory 90 includes an operating system 92 which implements the process flow 62 (FIG. 4), among other tasks. A portion of the memory 90 is designated as a buffer cache. The buffer cache comprises file block sized units called buffer cache blocks. Associated with each buffer cache block are the logical and physical attributes of a file block stored within that buffer cache block. The contents of the buffer cache blocks as well as the logical and physical attributes of the file blocks stored within the buffer cache blocks are summarized in buffer cache table 94. The logical and physical attributes shown in the buffer cache table 94 are preferably stored in primary and secondary buffer cache indexes, such as the primary and secondary buffer cache indexes 52 and 54 (FIG. 2). As shown in the buffer cache table 94, the file blocks associated with file one have previously been loaded into the buffer cache and occupy the 1^{st}, 2^{nd} and 3^{rd} buffer cache blocks. The 4^{th}, 5^{th} and 6^{th} buffer cache blocks of the buffer cache, 25 represented by the buffer cache contents row of table 94 are shown as empty in FIG. 5.

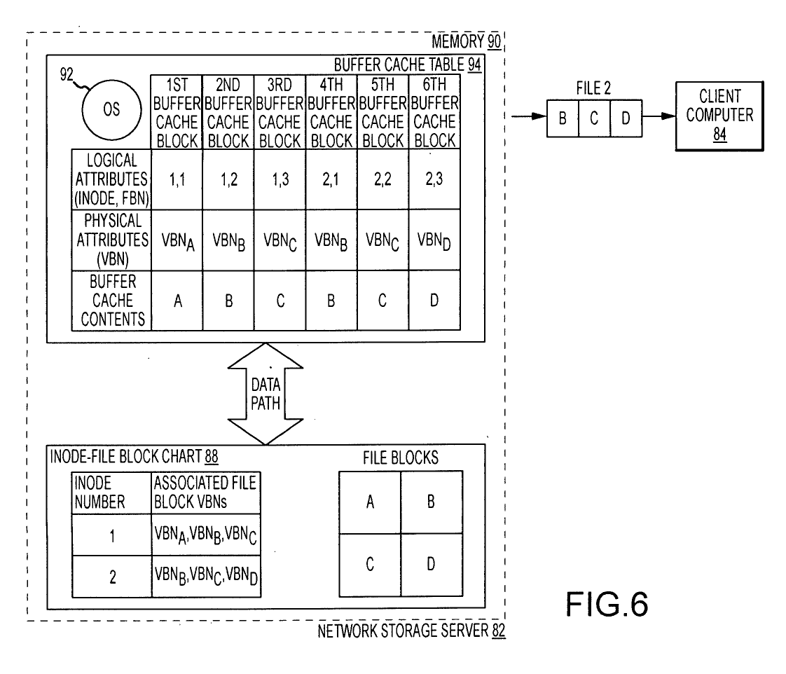

The client computer 84 is shown issuing a file request 96 to the network storage server 82 for file two. The operating system 92 receives the file request 96 and follows the process flow 62 (FIG. 4) for each file block associated with file two. The operating system 92 determines that the logical attributes associated with file two are the number two (the inode number of file two) and FBNs 1-3, according to 66 of the process flow 62. The operating system 92 then interrogates the primary buffer cache index (represented by the logical attributes row of the buffer cache table 94) to determine if the logical attributes for the file blocks of file two are present within the memory 90. As shown in the buffer cache table 94, the logical attributes associated with file two are not present within the primary buffer cache index. The operating system 92 then determines the physical attributes of the file blocks associated with file two, according to 72 of the process flow 62 (FIG. 4). The physical attributes of file blocks in this example are VBN numbers, and are represented by the word VBN and the subscript of the letter identifying the file block. The operating system 92 determines that the physical attributes of the file blocks associated with file two are VBN_{B}, VBN_{C}, and VBN_{D} by reading the inode file and the file block pointers of the volume 86, whose relevant information is shown in the inode-file block chart 88. The operating system 92 then searches the secondary buffer cache index for VBN_{B}, VBN_{C}, and VBN_{D}, according to 74 of the process flow 62 (FIG. 4). As shown in the physical attributes row of the buffer cache table 94, VBN_{B} and VBN_{C} are present within the secondary buffer cache index. Since VBN_{B} and VBN_{C} are present within the secondary buffer cache index, file blocks B and C are already present within the buffer cache and do not need to be read from the volume 86 to service the file request 96 from the client computer 84. The operating system 92 then copies file blocks B and C from the 2^{nd} and 3^{rd} buffer cache blocks to the 4^{th} and 5^{th} buffer cache blocks (which were previously empty) of the buffer cache and updates the buffer cache indexes with the logical and physical attribute information for these two file blocks, according to 76 of the process flow 62 (FIG. 4), as shown in FIG. 6. The operating system 92 also loads file block D into the 6^{th} buffer cache block of the buffer cache from the volume 86 and updates the buffer cache indexes with the logical and physical attribute information for file block D, according to 78 of the process flow 62, as shown in FIG. 6. The operating system X then sends file two to the client computer 84.

Searching the secondary buffer cache index for the physical attributes of the requested file block instead of just searching the primary buffer cache index for the logical attributes of the requested file block avoids extra disk operations for deduplicated file blocks. Disk operations take much longer to complete than do memory operations. Avoiding a disk operation thus improves the performance of the computer and reduces the total amount of processing time consumed by a given process to accomplish a given task involving the use of deduplicated file blocks. The extent of the performance improvement corresponds to the degree to which data has been deduplicated on the computer. Thus, the performance of a computer having a high degree of deduplicated data is greatly improved as a result of incorporating the present invention. Of course, the secondary and primary buffer cache indexes may be combined into a single index in other embodiments of the present invention. Also, other embodiments of the present invention may involve different sets of logical or physical attributes.

A presently preferred embodiment of the present invention and many of its improvements have been described with a degree of particularity. This description is a preferred example of implementing the invention, and is not necessarily intended to limit the scope of the invention. The scope of the invention is defined by the following claims.

What is claimed:

1. A method of responding to a request to copy a file block into the memory of a computer, the computer having a CPU, a memory and a persistent data storage device, the method comprising:
receiving a request to copy the file block into the memory;
determining physical attributes associated with the file block;
searching a memory index for the determined physical attributes;
copying the file block from a source address in the memory to a destination address in the memory when the determined physical attributes are present within an entry of the memory index;
copying the file block from the persistent data storage device to a destination address within the memory when the determined physical attributes are not present within an entry of the memory index; and
responding to the request with the destination address.

2. A method as defined in claim 1, additionally comprising:
determining logical attributes associated with the file block;
searching the memory index for the determined logical attributes; and
searching the memory index for the determined physical attributes when the determined logical attributes are not present within an entry of the memory index.

3. A method as defined in claim 1, wherein the aforementioned memory index is a secondary memory index, the computer further comprising a primary memory index, the method further comprising:
determining logical attributes associated with the file block;
searching the primary memory index for the determined logical attributes; and
searching the secondary memory index for the determined physical attributes when the determined logical attributes are not present within an entry of the primary memory index.

4. A method as defined in claim 3, wherein:
the logical attributes of the file block uniquely identify both a file of which the file block is a part and the position of the file block within the file; and
the physical attributes of the file block uniquely identify a location within the persistent data storage device in which the file block is stored.

5. A method as defined in claim 4, wherein the logical attributes include an inode number of the file and a file block number of the file block.

6. A method as defined in claim 4, wherein the physical attributes include at least one of a volume block number or a physical block number.

7. A method as defined in claim 4, wherein the primary and secondary memory indexes are stored within the memory.

8. A computer having deduplicated data, comprising:
a central processing unit;
one or more persistent data storage devices supplying data storage space;
a volume comprising the data storage space supplied by the one or more persistent data storage devices;
a plurality of files each comprising one or more file blocks, each file block within a file associated with a unique set of logical attributes, each of the file blocks stored within the volume at a unique volume address, each file block associated with a set of physical attributes related to the unique volume address at which the file block is stored, at least one file block being a deduplicated file block associated with two or more sets of logical attributes;
a memory having a plurality of unique memory addresses, copies of some of the file blocks stored within the volume located within the memory at some of the memory addresses;
an operating system executed by the central processing unit and stored in the memory;
a buffer cache index stored within the memory, the buffer cache index associating memory addresses with physical attributes corresponding to file blocks stored at those memory addresses; and wherein:
the operating system determines whether or not a particular file block is present within the memory by searching the buffer cache index for an entry containing the physical attributes associated with that particular file block.

9. A computer having deduplicated data as defined in claim 8, wherein the aforementioned buffer cache index is a secondary buffer cache index, the computer further comprising:
a primary buffer cache index stored within the memory, the primary buffer cache index associating memory addresses with logical attributes corresponding to file blocks stored at those memory addresses; and wherein:
the operating system determines whether or not a particular file block is present within the memory by searching the primary buffer cache index for the logical attributes corresponding to the particular file block and searching the secondary buffer cache index for the physical attributes corresponding to the particular file block.

10. A method of copying a deduplicated file block into a memory of a computer, comprising:
receiving a request to copy the deduplicated file block into the memory, the request including at least one logical attribute of the deduplicated file block;
determining at least one physical attribute associated with the deduplicated file block;
searching for the at least one physical attribute associated with the deduplicated file block in a buffer cache index;
copying the deduplicated file block from a source address in the memory to a destination address in the memory when the at least one physical attribute associated with the deduplicated file block is found within the buffer cache index; and
updating the buffer cache index with the at least one physical attribute associated with the deduplicated file block at an entry within the buffer cache index corresponding to the destination address.

11. A method as defined in claim 10, further comprising:
determining at least one logical attribute associated with the deduplicated file block; and
searching for the at least one logical attribute associated with the deduplicated file block in the buffer cache index.

12. A method as defined in claim 11, further comprising:
searching for the at least one physical attribute associated with the deduplicated file block in the buffer cache index when the at least one logical attribute associated with the deduplicated file block is not present within the buffer cache index.

13. A method as defined in claim 12, further comprising:
copying the deduplicated file block from a location within a persistent data storage device corresponding to the at least one physical attribute of the deduplicated file block to the destination address within the memory when neither the at least one logical attribute or the at least one physical attribute associated with the deduplicated file block are present within the buffer cache.

14. A method as defined in claim 13, further comprising:
updating the buffer cache index with the at least one logical attribute associated with the deduplicated file block at an entry within the buffer cache index corresponding to the destination address.

15. A method as defined in claim 14, further comprising:
responding to the request to copy the deduplicated file block into the memory with the destination address of the memory to which the deduplicated file block was copied.
